(19) United States
(12) Patent Application Publication
(10) Pub. No.: US 2020/0290438 A1
(43) Pub. Date: Sep. 17, 2020

(54) SUN VISOR SYSTEM

(71) Applicant: Beverley Jenkins, Brampton (CA)

(72) Inventor: Beverley Jenkins, Brampton (CA)

(21) Appl. No.: 16/354,479

(22) Filed: Mar. 15, 2019

(51) Int. Cl. B60J 3/02; B60J 3/04; G02B 5/23; B60Q 3/252

(52) U.S. Cl. CPC B60J 3/0204; B60Q 3/252; G02B 5/23; B60J 3/04

(57) ABSTRACT

A sun visor system for reducing glare in a vehicle is presented. The sun visor system has a roof mounted antenna which determines the amount of exterior sun light for a lighted mirror. The sun visor is preferably significantly larger than a standard sun visor. An oversized portion of the sun visor provides a protection for a larger area. The oversized portion of the sun visor is preferably between one and two (1-2) inches. The sun visor is initiated by automatically activated UV lighting in photochromatic material in the transitional sun visor of the sun visor system. The roof mounted antenna is coupled to the sun visor by small hinges or swivels that allow the lighted mirror to move in one direction only, to the driver or passenger window with no glare to passing traffic. Thusly, it extends clear vision and extends further sun light reduction.

### FIELD OF THE INVENTION

This invention relates to sun visors. More particularly, it relates to transitional sun visors.

### BACKGROUND

Sun visors made by automobile manufacturers protect the driver from sun glare when the sun is directly in front of him or her. If the sun is to the side of the driver or front seat passenger, positioning the existing sun visor on the side, adjacent to the user, does not always prevent the user from being irritated by the sun.

If the sun's rays come from the side of the user into the car, the user can turn the standard visor to the adjacent side window, but since very few roads are straight as an arrow, as the vehicle turns while driving, the angle of incidence of the light also changes as his directionality changes. Thus, he is susceptible to sun glare from the now unprotected side area.

Sun visors are a fairly uniform size and since they are opaque, they cannot be so wide that they would block the rear-view mirror or extended too far downward since they would then block the vision of the driver or front seat passenger.

Consequently, the sun glare often affects the user's eyes below the lowest position of the visor and the uppermost rear corner area of the side window such that the visor offers no sun protection to the user unless he strains upward or forward.

There are a few characteristics which a successful sun shield product must possess. It must be universally adaptable for use on all or at least most all motor vehicle models. The product must be easily accessed by the user and readily adjusted to the particular condition. The product also must be inexpensive. To date, no product intended for use in blocking out sun glare in motor vehicles has been developed which truly has all the aforementioned characteristics.

### BRIEF DESCRIPTION OF THE DRAWINGS

FIG. 1 is an illustrated view of an exemplary sun visor system.

FIG. 2 is an illustrated second view of the exemplary sun visor system of FIG. 1.

FIG. 3 is an illustrated third view of the exemplary sun visor system of FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

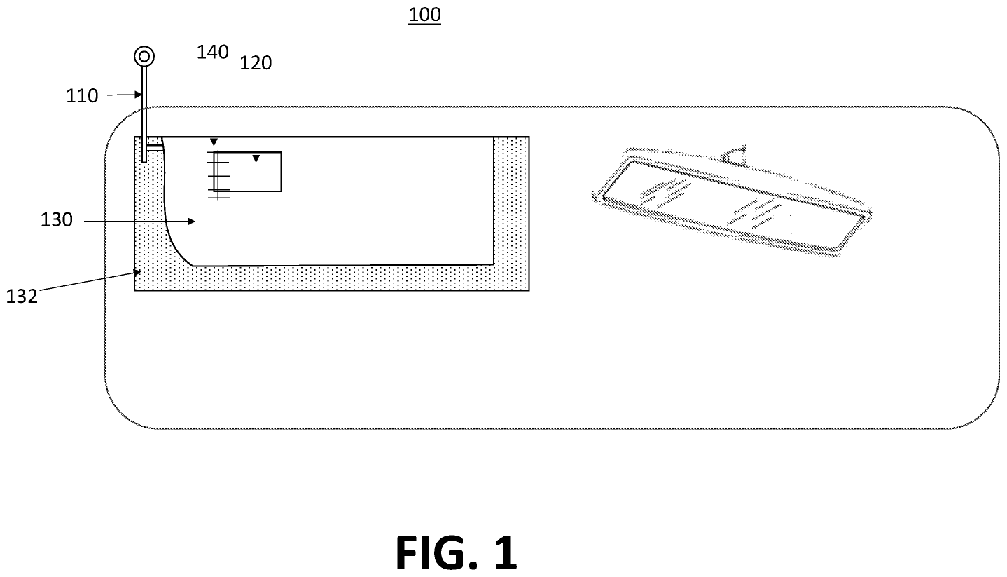

Referring to FIG. 1, an exemplary sun visor 100 is illustrated. The sun visor system 100 is useful in protecting the driver from sun glare and thus providing safer driving of a vehicle and preventing accidents, collisions and deaths on the roadways. The sun visor 100 is typically an oversized sun visor. The oversized portion 132 of the sun visor 100 provides a greater area of protection from that afforded by a standard sun visor. The oversized portion 132 of the sun visor 130 is preferably between one and two (1-2) inches, but may be any other size such as one-half (0.5) inch, three (3) inches, etc.

The sun visor system 100 has a roof mounted antenna 110, a lighted mirror 120 and a transitional sun visor 130. The transition sun visor 130 is initiated by automatically activated UV lighting in photochromatic material in the transitional sun visor 130 of the sun visor system 100.

Optionally and/or alternatively, the roof mounted antenna 110 is attached to the outside of the vehicle and detects exterior lighting. The roof mounted antenna 110 can be made of any durable material such as hard plastic, aluminum, steel, etc.

The roof mounted antenna 110 of the sun visor system 100 is communicatively coupled to the lighted mirror 120 of the sun visor system 100, further the lighted mirror is coupled to the lighted mirror 120 with hinges 140 or swivels (not shown), thus is swiveledly hinged to easily extend the lighted mirror 120 to protect a driver or a passenger. The transition sun visor 130 has a translucent color, the color is in a color range of clear to grey, or alternative. Optionally and/or additionally, the lighted mirror 120 may illuminate in any color such as violet, green, etc. or it may be adjustable by the driver of the vehicle. The lighted mirror 120 may utilize light emitting diodes, LCDs, etc.

The lighted mirror 120 may be hinged 140 and swivel-able, thus it may be extended to the window direction. The extending of the lighted mirror 120 may be automatic dependent on the data received from the roof mounted antenna 110 of the sun visor system 100. The lighting of the lighted mirror 120 may also have the color change depending on the available sun light and conditions when open and dormant when not in use.

The lighted mirror 120 may supply lighting to the transition sun visor 130 of the sun visor system 100. The transition sun visor 130 responds to the sunlight and changes in the sunlight which allows for more lighting and reduce the glare the driver may experience due to the lighting condition determined by the roof mounted antenna 110 of the sun visor system 100.

As mentioned earlier, as the roof mounted antenna 110 of the sun visor system 100 detects changes in exterior lighting, the lighted mirror 120 of the sun visor system 100 may be extended outside of the transition sun visor 130. Thus, roof mounted antenna 110 is coupled to the transition sun visor 130 by small hinges 140 that allow the lighted mirror 120 to move in one direction only, to the passenger window with no glare to passing traffic. Thusly, it extends clear vision (photochromatic technology) and extends further sun light reduction.

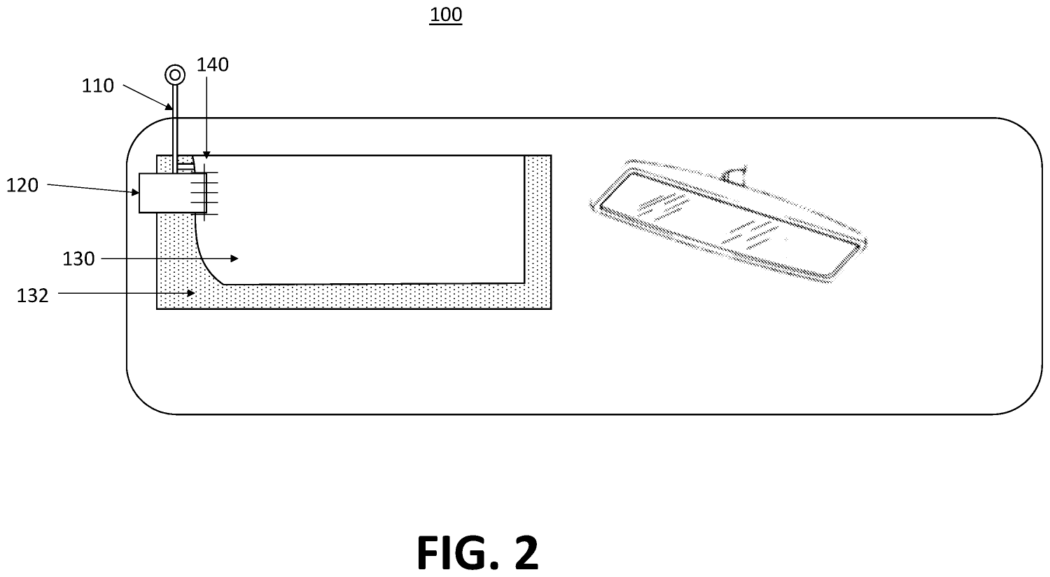

Moving now to FIG.2, a second view is illustrated in regards to the sun visor system of FIG. 1. The lighting detected by the roof mounted antenna 110 of the sun visor system 100 has changed and the sun visor system 100 is modified based on the detection by the roof mounted antenna 110 of the sun visor system 100.

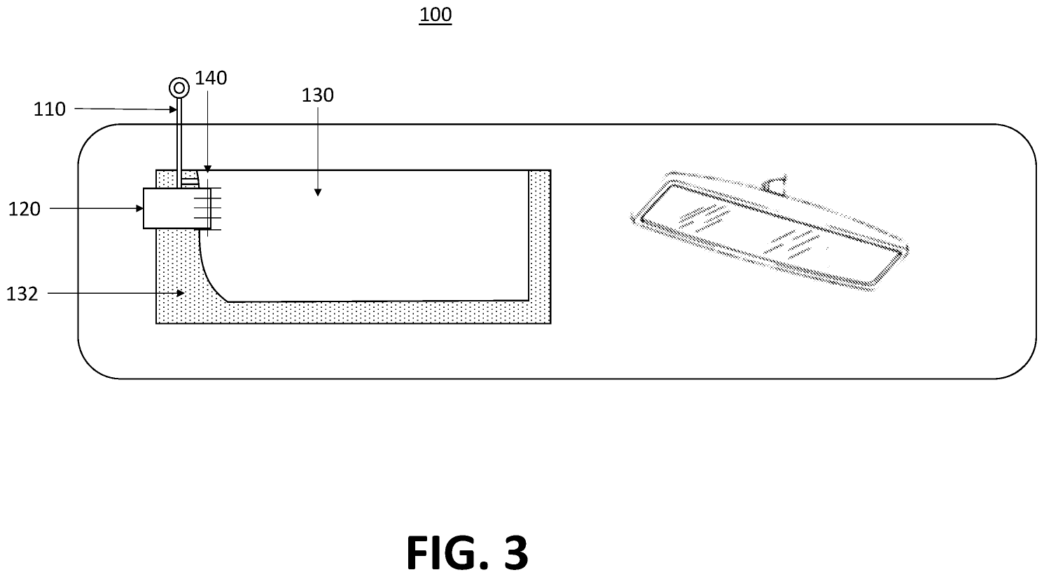

Moving now to FIG. 3, the sun visor system 100 of FIG. 2 is further modified. The sun visor system 100 has the lighted mirror 120 extended from the transition sun visor 130. The lighted mirror 120 moves from the transition sun visor 130 on the hinges 140.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A sun visor system for reducing glare in a vehicle, the sun visor system comprising:
a roof mounted antenna;
a lighted mirror, wherein the lighted mirror being communicatively coupled to the roof mounted antenna and wherein the roof mounted antenna determines the amount of exterior sun light for the lighted mirror;
a transition sun visor; wherein the transition sun visor receives the lighted mirror; and
the lighted mirror being lit based on data received from the determinations of the roof mounted antenna.

2. The sun visor system of claim 1, further comprising:
the transition sun visor being initiated by automatically activated UV lighting in photochromatic material in the sun visor.

3. The sun visor system of claim 2, wherein the transition sun visor being a color range of clear to grey.

4. The sun visor system of claim 1, wherein the lighted mirror being extended outside of the transition mirror by hinges.

5. The sun visor system of claim 1, wherein the lighted mirror being extended outside of the transition mirror by swivels.

6. The sun visor system of claim 1, wherein the glare is reduced by the lighting of the transition sun visor automatically by UV lighting.

7. The sun visor system of claim 1, wherein the roof mounted antenna being made of a hard-plastic material.

8. The sun visor system of claim 1, wherein the lighted mirror being lit by LCD.

9. The sun visor system of claim 1, wherein the transition sun visor being lit by UV lighting.

10. The sun visor system of claim 1, further comprising:
a larger sun visor, wherein a gap between the transition sun visor and the rear-view mirror being reduced by the larger sun visor.
